(19) United States
(12) Patent Application Publication
(10) Pub. No.: US 2026/0223024 A1
(43) Pub. Date: Jul. 30, 2026

(54) SYNCHRONIZATION PROCEDURE FOR ULTRA-LIGHT

(71) Applicant: QUALCOMM Incorporated, San Diego, CA (US)

(72) Inventors: Xiaojie WANG, Hillsborough, NJ (US); Luanxia YANG, Beijing (CN); Piyush GUPTA, Bridgewater, NJ (US); Junyi LI, Greentown, PA (US)

(21) Appl. No.: 19/145,183

(22) PCT Filed: Feb. 22, 2023
(86) PCT No.: PCT/CN2023/077555

§ 371 Date: Jul. 1, 2025

(51) Int. Cl. H04W 56/00; H04L 27/04

(52) U.S. Cl. CPC H04W 56/0015; H04L 27/04

(57) ABSTRACT

A network entity may select a PSS. The PSS may be associated with an OOK bit sequence or a single carrier waveform. The network entity may transmit, for a UE, the PSS based on a synchronization raster. The synchronization raster is a multiple of a channel raster. The UE may synchronize with the network entity based on the received PSS. In one configuration, the PSS may include a time domain synchronization signal based on the single carrier waveform. In one configuration, the PSS may include a predefined OOK bit sequence.

### TECHNICAL FIELD

The present disclosure relates generally to communication systems, and more particularly, to synchronization signals for ultra-light devices in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The apparatus may receive a primary synchronization signal (PSS) from a network entity based on a synchronization raster. The PSS may be associated with an on-off keying (OOK) bit sequence or a single carrier waveform. The apparatus may synchronize with the network entity based on the received PSS.

In an aspect of the disclosure, a method, a computer-readable medium, and an apparatus are provided. The apparatus may be a network entity. The apparatus may select a PSS. The PSS may be associated with an OOK bit sequence or a single carrier waveform. The apparatus may transmit, for a UE, the PSS based on a synchronization raster.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example synchronization signal (SS)/physical broadcast channel (PBCH) (SS/PBCH) block for the NR.

FIG. 5 is a diagram illustrating synchronization signals for the narrowband—internet of things (NB-IoT).

FIG. 6 is a diagram illustrating repeated sequences in a PSS.

FIG. 7 is a diagram of a communication flow of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Multiple device/UE classes with varying capabilities may be used in a wireless communication system. For example, different device/UE classes may be associated with different bandwidths, different antenna configurations, and/or different peak data rates. The ultra-light IoT (or simply “ultra-light” hereinafter) may be a device class situated between the NB-IoT and the passive IoT. An ultra-light device/UE may be less capable than an NB-IoT device/UE but more capable than a passive IoT device/UE. For example, an ultra-light device/UE may have a bandwidth between 100 kHz and 180 kHz, may have a single transmit antenna and a single receive antenna (a single antenna may serve as both), and may have a peak data rate under 25 kilobits per second (kbps). Synchronization signals that may accommodate the characteristics of the ultra-light device/UE may be useful.

In some example aspects, a network entity may select a PSS. The PSS may be associated with an OOK bit sequence or a single carrier waveform. The network entity may transmit, for a UE, the PSS based on a synchronization raster. The UE may synchronize with the network entity based on the received PSS. Accordingly, a suitable PSS may be provided for an ultra-light device/UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

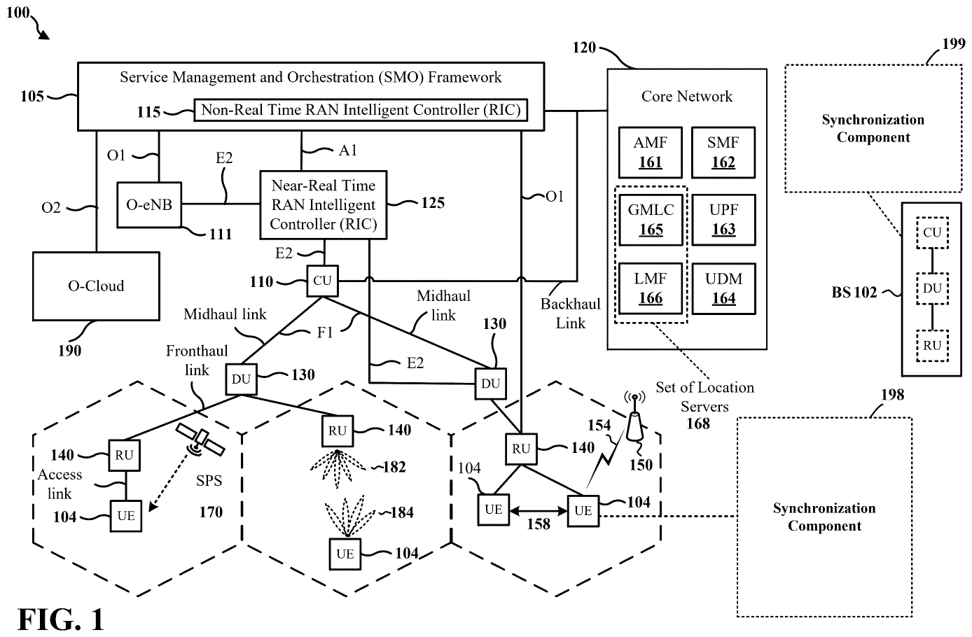

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a synchronization component 198 that may be configured to receive a PSS from a network entity based on a synchronization raster. The PSS may be associated with an OOK bit sequence or a single carrier waveform. The synchronization component 198 may be configured to synchronize with the network entity based on the received PSS. In certain aspects, the base station 102 may have a synchronization component 199 that may be configured to select a PSS. The PSS may be associated with an OOK bit sequence or a single carrier waveform. The synchronization component 199 may be configured to transmit, for a UE, the PSS based on a synchronization raster.

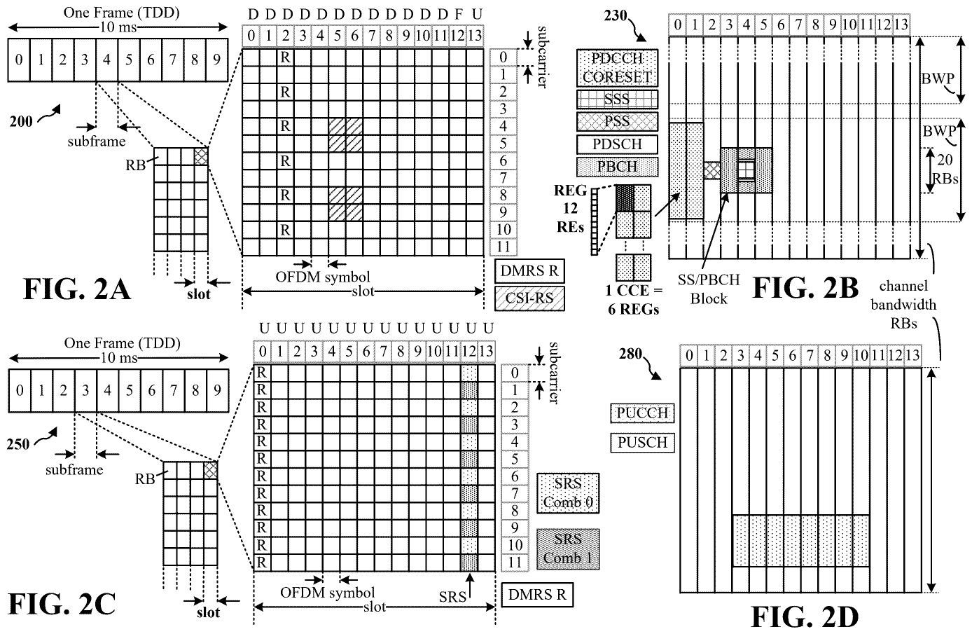

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (SCs) (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology p=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

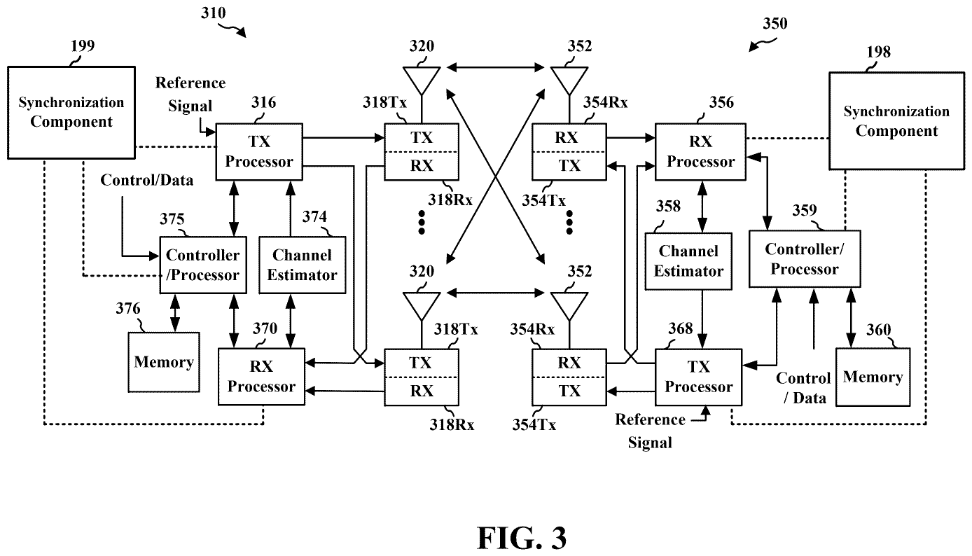

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the synchronization component 198 of FIG. 1.

At least one of the TX processor 316, the RX processor 370, and the controller/processor 375 may be configured to perform aspects in connection with the synchronization component 199 of FIG. 1.

Multiple device/UE classes with varying capabilities may be used in a wireless communication system. For example, different device/UE classes may be associated with different bandwidths, different antenna configurations, and/or different peak data rates. The ultra-light IoT (or simply “ultra-light” hereinafter) may be a class situated between the NB-IoT and the passive IoT. An ultra-light device/UE may be less capable than an NB-IoT device/UE but more capable than a passive IoT device/UE. For example, an ultra-light device/UE may have a bandwidth between 100 kHz and 180 kHz, may have a single transmit antenna and a single receive antenna (a single antenna may serve as both), and may have a peak data rate under 25 kbps. Synchronization signals that may accommodate the characteristics of the ultra-light device/UE may be useful.

Synchronization signals in a wireless communication system (e.g., an LTE system, an NR system, or a future wireless communication system) may serve multiple purposes. For example, synchronization signals may enable initial time and frequency synchronization. Further, synchronization signals may help to signal, and may enable other devices (e.g., UEs) to identify, the PCI of the cell. For example, the NR may support 1008 PCIs, which may be organized into 336 (Nff) groups each including 3 (NID)) PCIs. Moreover, synchronization signals may enable the completion of signal strength/quality measurements (e.g., reference signal received power (RSRP), reference signal received quality (RSRQ), or signal-to-interference-plus-noise ratio (SINR) measurements) (e.g., based on the SSS). Furthermore, the SSS may also be used as an additional DM-RS for the PBCH.

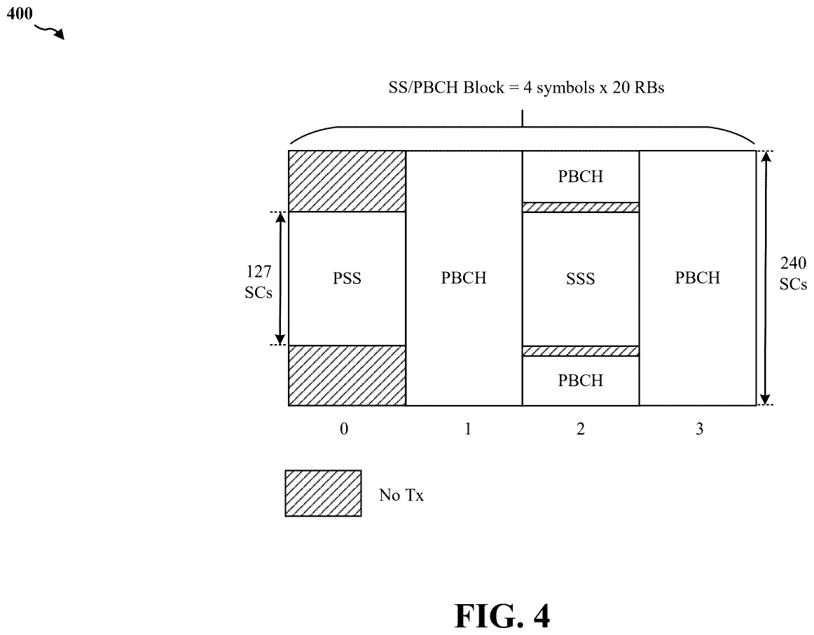

FIG. 4 is a diagram illustrating an example SS/PBCH block 400 for the NR. As shown, the SS/PBCH block 400 may span 4 symbols in time and 20 RBs in frequency. The SS/PBCH block 400 may include one PSS, one SSS, and a number of PBCHs. In some configurations of the NR, each of the PSS and the SSS may be a sequence of 127 BPSK symbols. The PSS and the SSS may be based on a maximum length sequence (m-sequence). In particular, the PSS may be generated based on applying 1 of 3 cyclic shifts to the length-127 sequence (e.g., cyclic shifts of 0, 43, or 86 depending on NID). The SSS may be generated as a product of 2 sequences, where one of the 2 sequence may be generated by applying a cyclic shift m0, which may be determined based on NID and NID, and the other of the 2 sequences may be generated by applying a cyclic shift m1, which may be determined based on N.

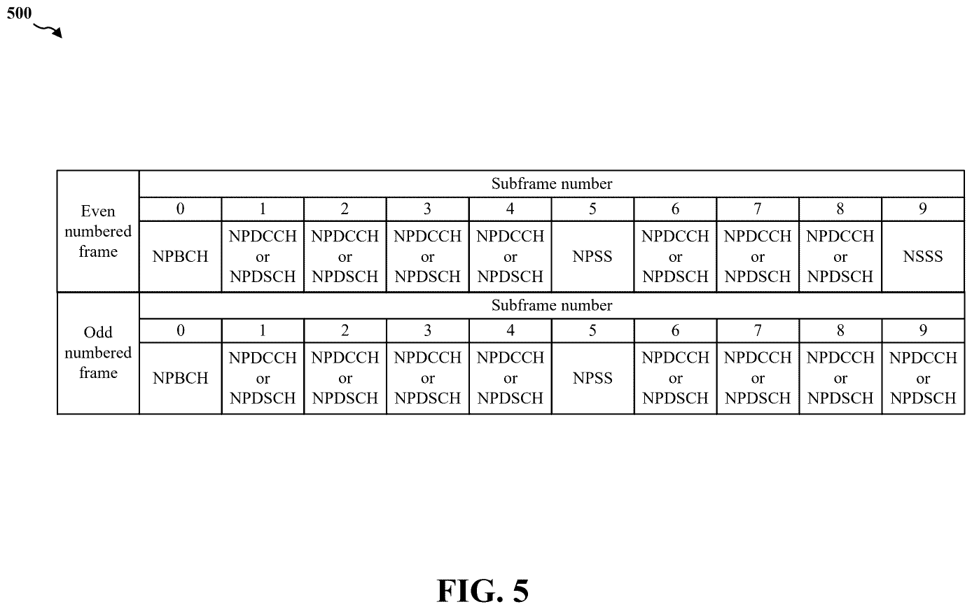

FIG. 5 is a diagram 500 illustrating synchronization signals for the NB-IoT. As shown, the narrowband PSS (N-PSS or NPSS) may be transmitted in Subframe #5 using the last 11 OFDM symbols in each 10 ms frame. Further, the narrowband SSS (N-SSS) may be transmitted in Subframe #9 every 20 ms (e.g., in just even-numbered frames) using the last 11 OFDM symbols. The PHY layer design of the NPSS and the NSSS may be common for all deployment scenarios. In particular, no cell-specific reference signal (CRS) assumptions may be provided for stand-alone and/or guard-band deployment. Further, for in-band deployment, the NPSS/NSSS transmission may be punctured if a CRS present. Moreover, the NPSS/NSSS may be excluded from the first three symbols to avoid any impact on the legacy control region as for the in-band deployment.

In some configurations, the UE may search for the SSs/PBCH based on a synchronization raster (the synchronization raster may indicate frequency positions of the SSs/PBCH). The synchronization raster may be associated with global synchronization channel numbers (GSCNs). For example, in the NR, the UE may search for the SSs/PBCH every 100 kHz for frequencies under 3 GHz, every 1.44 MHz for frequencies between 3 GHz and 24.25 GHz, or every 17.28 MHz for frequencies between 24.25 GHz and 100 GHz.

In some configurations, an ultra-light UE may search for the SSs/PBCH based on a sparse synchronization raster (e.g., sparser than for the regular NR, or sparser than the channel raster (the channel raster may be the same as the synchronization raster for the regular NR)). A synchronization raster being more sparse may correspond to neighboring SSs/PBCHs being further apart in frequency. For example, in some configurations, the synchronization raster for the ultra-light may be a multiple (i.e., a number of times) of the channel raster (the synchronization raster for the regular NR). In non-limiting examples, the channel raster may be (every) 200 kHz (or any other suitable value). In one example configuration similar to that for the regular NR, the synchronization raster for the ultra-light may be the same as the channel raster. In other words, an ultra-light device/UE may search every potential channel for the SSs/PBCH. In another non-limiting example configuration, the synchronization raster for the ultra-light may be 4 times the channel raster (e.g., 4*200 kHz), such that the network may broadcast the SS/PBCH block for the ultra-light every 4 channels. To generalize, the synchronization raster for the ultra-light may be n times the channel raster (e.g., n*200 kHz), where n may be an integer greater than 1, such that the network may broadcast the SS/PBCH block for the ultra-light every n channels. Using a sparse synchronization raster (e.g., a synchronization raster that is a multiple of the channel raster) may reduce the cell search complexity. In some configurations, the network may signal the presence of other channels for the ultra-light devices/UEs using channels that may include SS/PBCH blocks for the ultra-light devices/UEs (such channels may be referred to as synchronization channels). Accordingly, once the presence of other channels (i.e., non-synchronization channels) is signaled to the ultra-light devices/UEs, the network may schedule communications for in-sync ultra-light devices/UEs on the non-synchronization channels.

A non-limiting example of a synchronization raster configuration for the ultra-light may be provided in Table 2 below.

TABLE 2
Example Synchronization Raster Configuration for the Ultra-Light

| | | SS/PBCH | | | | |
|---|---|---|---|---|---|---|
| Frequency | | Frequency | | | | GSCN |
| Range | | Positions | N | M | GSCN | Range |
| 0-3 | GHZ | 1.2N MHz + | 1-2944 | 1, 3, 5 | 3N + | 2-7498 |
| | | 50M kHz | | | (M − 3)/2 | |
| 3-24.25 | GHz | 2400 MHz + | 0-14756 | — | 7499 + N | 7499- |
| | | 1.44N MHz | | | | 22255 |
| 24.25-100 | GHz | 24250.08 MHz + | 0-4383 | — | 22256 + N | 22256- |
| | | 17.28N MHz | | | | 26639 |

The PSS and SSS design for the regular NR may not suit ultra-light devices/UEs for a number of reasons. For example, an (ultra-light) demodulator at an ultra-light device/UE may be based on the single carrier waveform or envelope tracking (e.g., for OOK sequences). Further, the processing capability of an ultra-light device/UE may be limited, which may affect the processing time for PSS detection, and may impose a limit on the search space for different sequences.

In one or more configurations, the PSS for the ultra-light may be based on OOK sequences. In different configurations, at least one of a Zadoff-Chu (ZC) sequence, an m-sequence, Gold codes, a Barker sequence, or a Kasami sequence may be used for the PSS for the ultra-light. In one configuration, the PSS for the ultra-light may include a single PSS, which may be suitable for low-complexity ultra-light devices/UEs that may perform cell searching.

In some configurations, an ultra-light device (e.g., an ultra-light UE) may include in-phase and quadrature (IQ) demodulation support. For such ultra-light devices/UEs, a PSS based on a time domain ZC sequence or m-sequence (i.e., similar to the PSS for the NR/NB-IoT) may be used. In some other configurations, an ultra-light device (e.g., an ultra-light UE) may include just a single demodulation branch (i.e., no separate IQ demodulation branch). For such ultra-light devices/UEs, a PSS based on at least one real-valued sequence may be used.

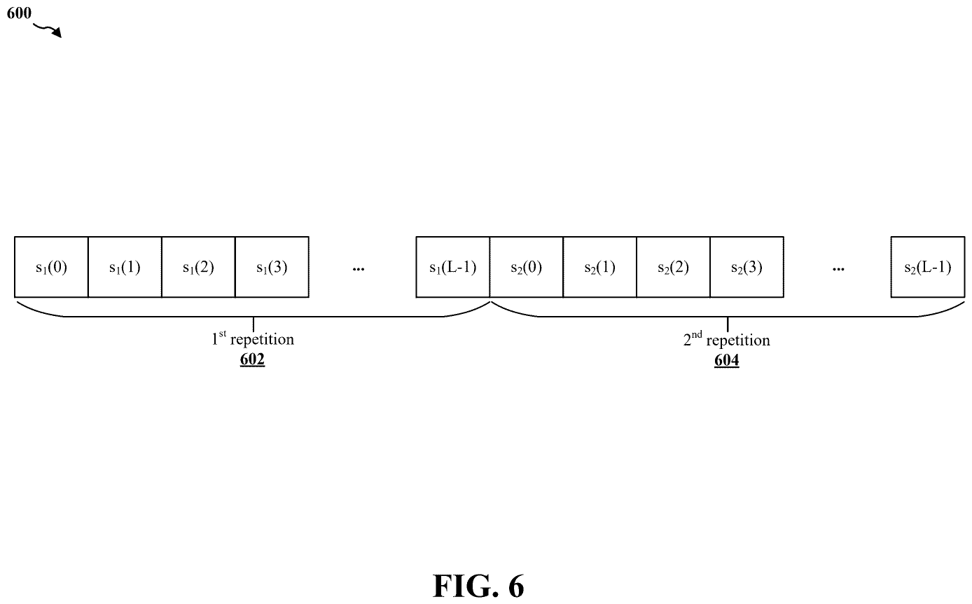

FIG. 6 is a diagram 600 illustrating repeated sequences in a PSS. For a PSS based on a time domain ZC sequence or m-sequence, the received PSS may be denoted by sₖ(n)·e^{j2π(kL+n)θ}, where θ may be induced by the carrier frequency offset (CFO), k may be the k-th repetition of the PSS, where a binary cover code may be applied to each repetition, and n may be the n-th sample of the length-L PSS within one repetition. The CFO may occur when the local oscillator signal for down-conversion in the receiver does not synchronize with the carrier signal contained in the received signal. The CFO, if left uncorrected, may result in inter-carrier interference (ICI). Further, the sequence may be obtained at a start sampling time τ. FIG. 6 shows two repetitions of the sequence sₖ including a first repetition 602 and a second repetition 604. In different configurations, the sequence may be/include any suitable low auto-correlation sequence (e.g., a ZC sequence, an m-sequence, etc.). Repeated short sequences may be associated with low complexity and satisfactory performance (e.g., when compared to a long sequence design).

In some configurations, an ultra-light device (e.g., an ultra-light UE) may apply auto-correlation across repetitions. An example auto-correlation operation may be represented as:

$${A}_{m} ( τ ) = \sum {l}_{k} {l}_{k + m} {s}_{k} ( n ) {s}_{k + m}^{*} ( n ) \cdot {e}^{j 2 π mL θ} ,$$

where lₖ may denote the binary cover code for the k-th repetition. Further, m may be equal to 1 for adjacent repetitions, and may be greater than or equal to 2 for non-adjacent repetitions.

In some configurations, an ultra-light device (e.g., an ultra-light UE) may estimate the timing based on a phase estimation (e.g., using a best linear unbiased estimator (BLUE)). A coarse timing estimation may be represented as:

$$ρ ( τ ) = {A}_{1} ( τ ) + \sum {w}_{q} {A}_{q}^{*} ( τ ) {A}_{q + 1} ( τ ) ,$$

where E[ρ(τ)]∝^{ej2πLθ}.

In some configurations, an ultra-light device (e.g., an ultra-light UE) may perform a coarse CFO estimation based on the phase information of the correlation peak. The coarse CFO estimation may be based on the formula E[ρ(τ)]∝e^{j2πLθ}, where the range of fractional CFO estimation may be 2πLθ in (−π, π]. Further, the ultra-light device (e.g., an ultra-light UE) may perform CFO correction in the range

$$( - \frac{1}{2 L} f , \frac{1}{2 L} f ) ,$$

where f may be the bandwidth.

In some configurations, an ultra-light device (e.g., an ultra-light UE) may further perform integer CFO correction based on cross-correlation. In particular, the ultra-light device/UE may correlate the received PSS with a local copy of the PSS (including applying timing and frequency shifts). In some configurations, the ultra-light device/UE may refine the timing and frequency estimates using oversampled signals. In particular, the integer CFO hypothesis may be on the order of

$$\frac{1}{L} f .$$

Accordingly, the 2-step auto-correlation and cross-correlation based estimation may allow a sufficient degree of freedom (DoF) at the UE side. In particular, the auto-correlation-based method may be more suitable in high CFO scenarios, and the cross-correlation-based method may be more suitable in low signal-to-noise ratio (SNR) scenarios.

For a PSS based on at least one real-valued sequence, correlation-based timing and frequency estimation may not be decoupled (in contrast, for a PSS based on a time domain ZC sequence or m-sequence, the timing estimation may be based on the amplitude of the correlation, whereas the CFO estimation may be based on the phase of the correlation peak; that is, the timing estimation and the frequency estimation may be decoupled) because the CFO may introduce amplitude variation. In some configurations, the received PSS based on at least one real-valued sequence may be denoted by sₖ(n)·cos(2π(kL+n)θ). Joint timing and CFO estimation in a 2-dimensional (2D) space based on the real-valued sequence-based PSS may lead to high complexity.

Accordingly, in some configurations where a PSS based on at least one real-valued sequence is used, an ultra-light device (e.g., an ultra-light UE) may perform just the timing estimation without performing CFO estimation. As such, the PSS may be designed just for timing acquisition.

In some configurations, as the CFO estimation is not available, an ultra-light device (e.g., an ultra-light UE) may use a free running oscillator for data transmissions. For example, a frequency offset up to 100 parts per million (ppm) may be tolerated for the initial cell search, and a smaller frequency offset may be tolerated for non-initial cell synchronization. Accordingly, the base station/network entity receiving from the ultra-light device/UE may account for the high CFO (e.g., due to the use of the free running oscillator) when receiving. In some configurations, non-coherent modulation schemes that may tolerate a high phase noise of the oscillator may be used. In some configurations, the ultra-light device/UE may not include a phase-locked loop (PLL) or other frequency correction loops. Rather, the ultra-light device/UE may include and use a (low-cost) digital controlled oscillator (DCO) with a slow frequency correction loop. In some configurations, the ultra-light device/UE may include a high-quality factor (“Q”) resonator. On the other hand, using a free running oscillator for data transmissions may not work well if the ultra-light device/UE does not include temperature/voltage-controlled oscillators.

In some configurations, as the CFO estimation is not available, an ultra-light device (e.g., an ultra-light UE) may not perform down-conversion (e.g., digital down-conversion) for data reception. In other words, for data reception, the ultra-light device/UE may perform amplitude detection without down-conversion. Accordingly, an oscillator may not be used (needed) for data reception. Based on the amplitude detection, the DL demodulator at the ultra-light device/UE may output just hard-decision bits (e.g., no soft samples). The hardware for the hard-decision with envelope tracking may have low complexity and low power consumption. In some configurations, a preconfigured bit sequence may be used as the PSS for timing acquisition (e.g., the bit/symbol level synchronization may suffice as compared to the sample level synchronization in OFDM-based waveforms).

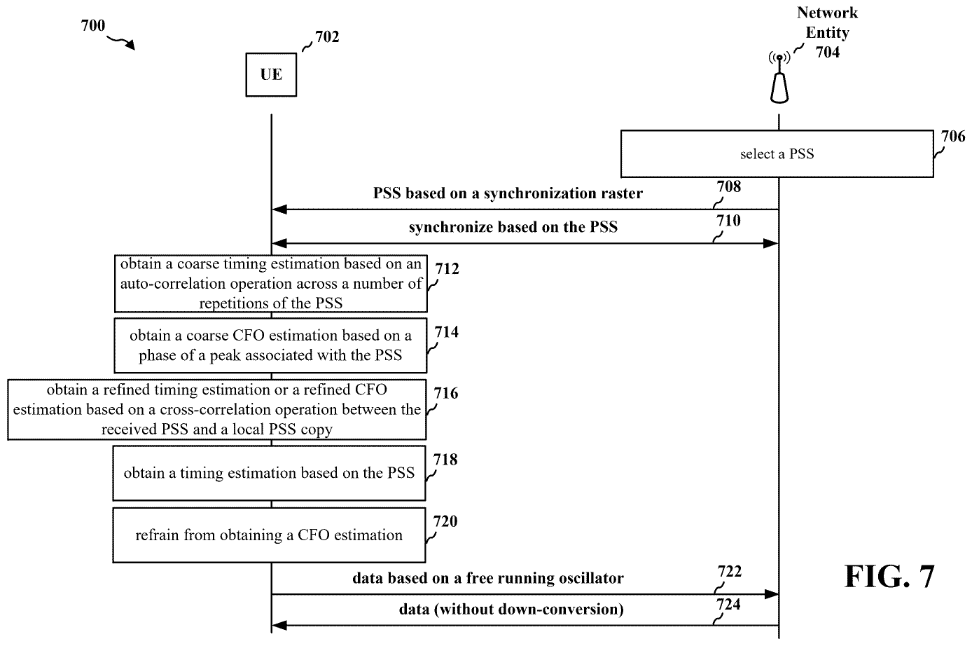

FIG. 7 is a diagram of a communication flow 700 of a method of wireless communication. The UE 702 may implement aspects of the UE 104/350. The UE 702 may correspond to an ultra-light device/UE. Further, the network entity 704 may implement aspects of the base station 102/310. At 706, the network entity 704 may select a PSS. The PSS may be associated with an OOK bit sequence or a single carrier waveform.

At 708, the network entity 704 may transmit, for the UE 702, the PSS based on a synchronization raster.

At 710, the UE 702 may synchronize with the network entity 704 based on the received PSS.

In one configuration, at 712, the UE 702 may obtain a coarse timing estimation based on an auto-correlation operation across a number of repetitions of the PSS at 708.

In one configuration, the synchronization raster may be a multiple of a channel raster.

In one configuration, the PSS at 708 may include a time domain synchronization signal based on the single carrier waveform.

In one configuration, the PSS at 708 may be associated with a number of repetitions.

At 714, the UE 702 may obtain a coarse CFO estimation based on a phase of a peak associated with the PSS at 708.

In one configuration, at 716, the UE 702 may obtain a refined timing estimation or a refined CFO estimation based on a cross-correlation operation between the received PSS at 708 and a local PSS copy.

In one configuration, the PSS at 708 may be based on a ZC sequence or an m-sequence.

In one configuration, the PSS at 708 may include the OOK bit sequence. The OOK bit sequence may be predefined.

In one configuration, at 718, the UE 702 may obtain a timing estimation based on the PSS (e.g., based on detecting the known PSS sequence) at 708.

At 720, the UE 702 may refrain from obtaining a CFO estimation.

In one configuration, at 722, the UE 702 may transmit, for the network entity 704, data based on a free running oscillator.

In one configuration, at 724, the UE 702 may receive data from the network entity 704 without performing down-conversion.

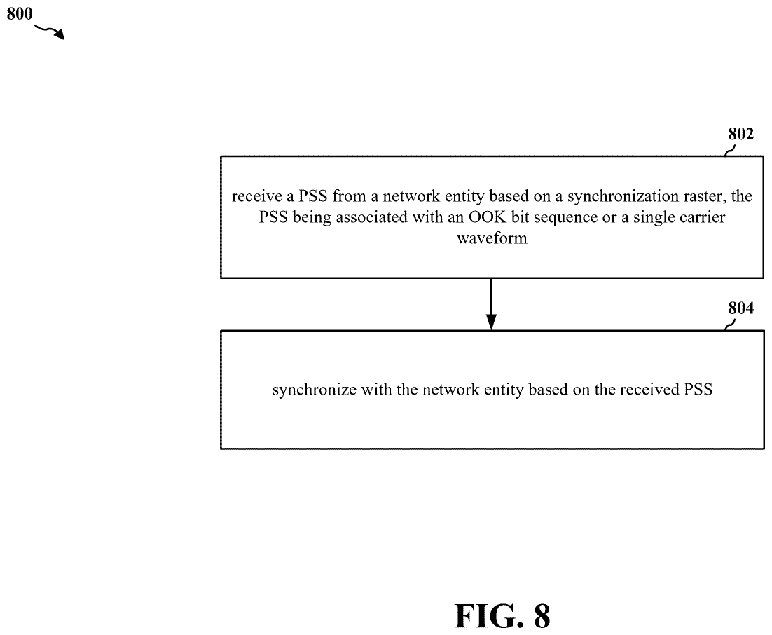

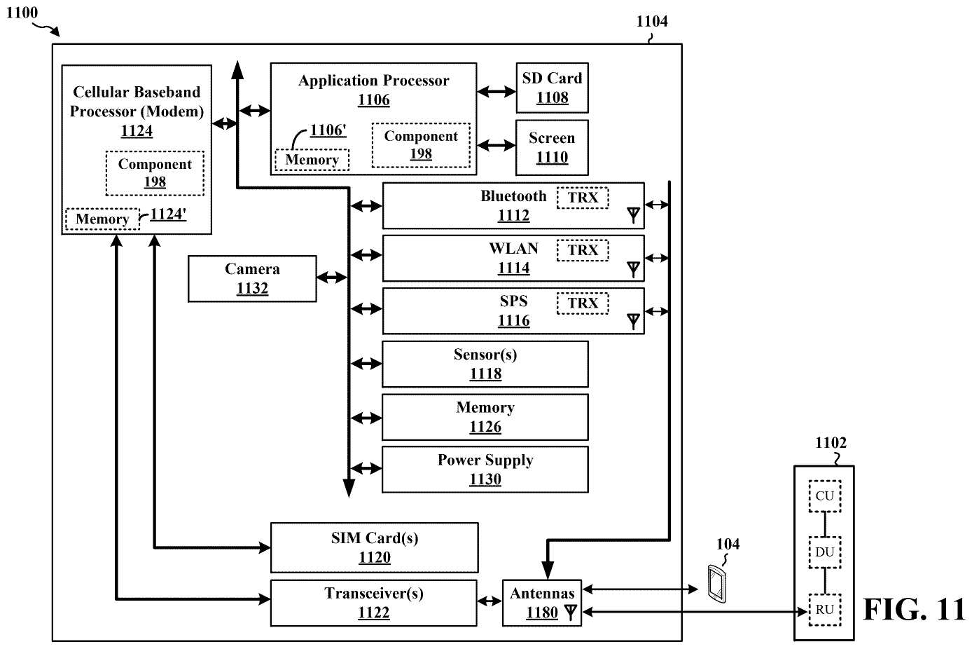

FIG. 8 is a flowchart 800 of a method of wireless communication. The method may be performed by a UE (e.g., the UE 104/350/702; the apparatus 1104). At 802, the UE may receive a PSS from a network entity based on a synchronization raster. The PSS may be associated with an OOK bit sequence or a single carrier waveform. For example, 802 may be performed by the component 198 in FIG. 11. Referring to FIG. 7, at 708, the UE 702 may receive a PSS from a network entity 704 based on a synchronization raster.

At 804, the UE may synchronize with the network entity based on the received PSS. For example, 804 may be performed by the component 198 in FIG. 11. Referring to FIG. 7, at 710, the UE 702 may synchronize with the network entity 704 based on the received PSS.

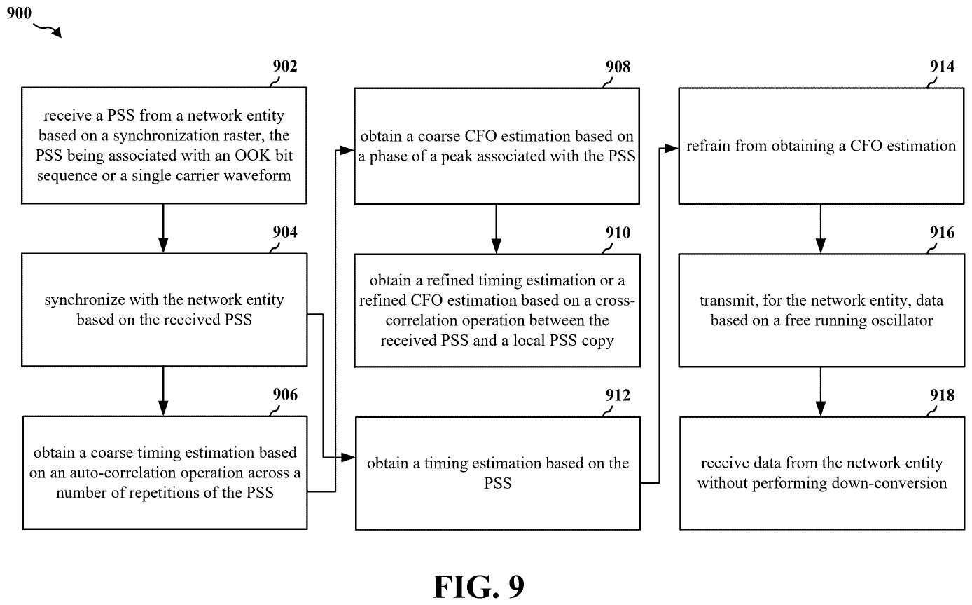

FIG. 9 is a flowchart 900 of a method of wireless communication. The method may be performed by a UE (e.g., the UE 104/350/702; the apparatus 1104). At 902, the UE may receive a PSS from a network entity based on a synchronization raster. The PSS may be associated with an OOK bit sequence or a single carrier waveform. For example, 902 may be performed by the component 198 in FIG. 11. Referring to FIG. 7, at 708, the UE 702 may receive a PSS from a network entity 704 based on a synchronization raster.

At 904, the UE may synchronize with the network entity based on the received PSS. For example, 904 may be performed by the component 198 in FIG. 11. Referring to FIG. 7, at 710, the UE 702 may synchronize with the network entity 704 based on the received PSS.

In one configuration, the synchronization raster may be a multiple of a channel raster.

In one configuration, referring to FIG. 7, the PSS at 708 may include a time domain synchronization signal based on the single carrier waveform.

In one configuration, referring to FIG. 7, the PSS at 708 may be associated with a number of repetitions.

In one configuration, at 906, the UE may obtain a coarse timing estimation based on an auto-correlation operation across a number of repetitions of the PSS. For example, 906 may be performed by the component 198 in FIG. 11. Referring to FIG. 7, at 712, the UE 702 may obtain a coarse timing estimation based on an auto-correlation operation across a number of repetitions of the PSS at 708.

At 908, the UE may obtain a coarse CFO estimation based on a phase of a peak associated with the PSS. For example, 908 may be performed by the component 198 in FIG. 11. Referring to FIG. 7, at 714, the UE 702 may obtain a coarse CFO estimation based on a phase of a peak associated with the PSS at 708.

In one configuration, at 910, the UE may obtain a refined timing estimation or a refined CFO estimation based on a cross-correlation operation between the received PSS and a local PSS copy. For example, 910 may be performed by the component 198 in FIG. 11. Referring to FIG. 7, at 716, the UE 702 may obtain a refined timing estimation or a refined CFO estimation based on a cross-correlation operation between the received PSS at 708 and a local PSS copy.

In one configuration, referring to FIG. 7, the PSS at 708 may be based on a ZC sequence or an m-sequence.

In one configuration, referring to FIG. 7, the PSS at 708 may include the OOK bit sequence. The OOK bit sequence may be predefined.

In one configuration, at 912, the UE may obtain a timing estimation based on the PSS. For example, 912 may be performed by the component 198 in FIG. 11. Referring to FIG. 7, at 718, the UE 702 may obtain a timing estimation based on the PSS at 708.

At 914, the UE may refrain from obtaining a CFO estimation. For example, 914 may be performed by the component 198 in FIG. 11. Referring to FIG. 7, at 720, the UE 702 may refrain from obtaining a CFO estimation.

In one configuration, at 916, the UE may transmit, for the network entity, data based on a free running oscillator. For example, 916 may be performed by the component 198 in FIG. 11. Referring to FIG. 7, at 722, the UE 702 may transmit, for the network entity 704, data based on a free running oscillator.

In one configuration, at 918, the UE may receive data from the network entity without performing down-conversion. For example, 918 may be performed by the component 198 in FIG. 11. Referring to FIG. 7, at 724, the UE 702 may receive data from the network entity 704 without performing down-conversion.

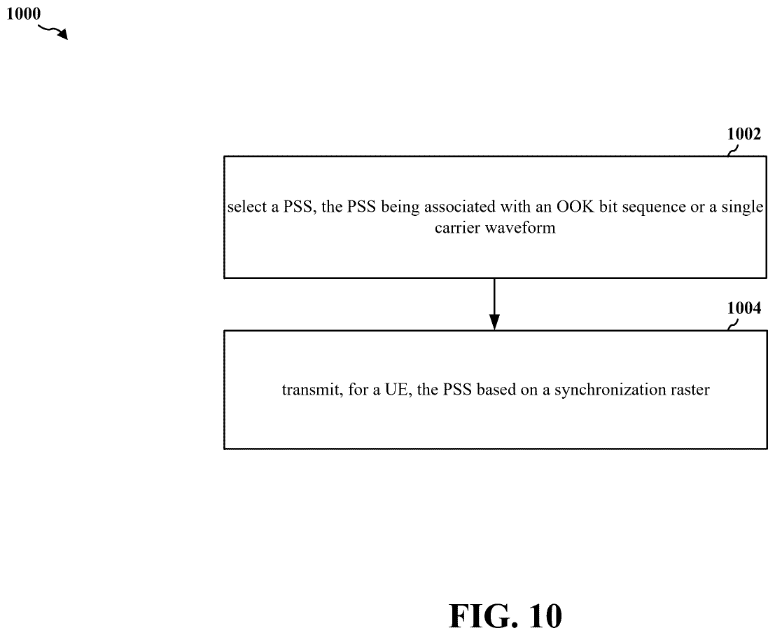

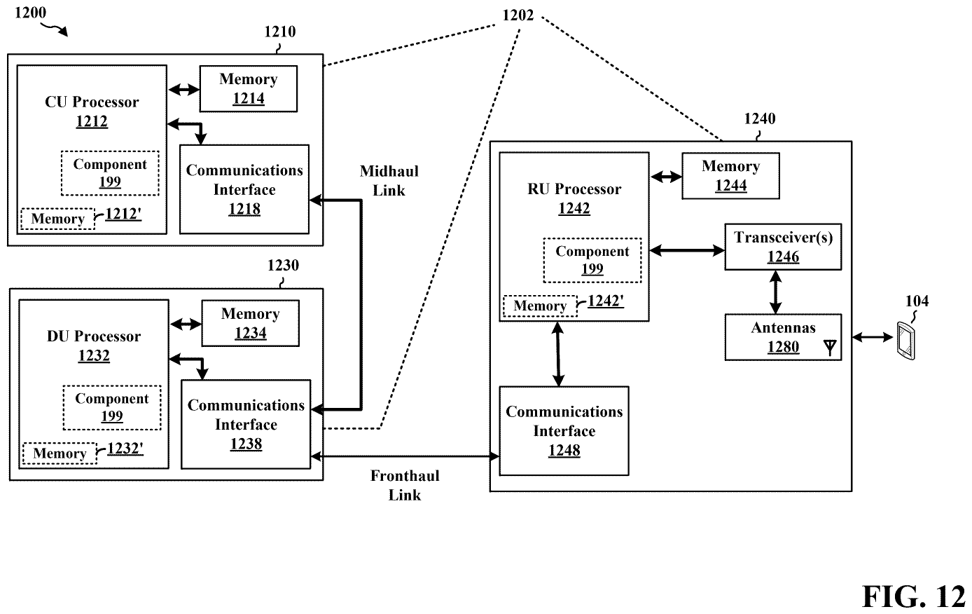

FIG. 10 is a flowchart 1000 of a method of wireless communication. The method may be performed by a network entity (e.g., the base station 102/310; the network entity 704; the network entity 1102, 1202). At 1002, the network entity may select a PSS. The PSS may be associated with an OOK bit sequence or a single carrier waveform. For example, 1002 may be performed by the component 199 in FIG. 12. Referring to FIG. 7, at 706, the network entity 704 may select a PSS.

At 1004, the network entity may transmit, for a UE, the PSS based on a synchronization raster. For example, 1004 may be performed by the component 199 in FIG. 12. Referring to FIG. 7, at 708, the network entity 704 may transmit, for a UE 702, the PSS based on a synchronization raster.

In one configuration, the synchronization raster may be a multiple of a channel raster.

In one configuration, referring to FIG. 7, the PSS at 708 may include a time domain synchronization signal based on the single carrier waveform.

In one configuration, referring to FIG. 7, the PSS at 708 may be associated with a number of repetitions.

In one configuration, referring to FIG. 7, the PSS at 708 may be based on a ZC sequence or an m-sequence.

In one configuration, referring to FIG. 7, the PSS at 708 may include the OOK bit sequence. The OOK bit sequence may be predefined.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

As discussed supra, the component 198 may be configured to receive a PSS from a network entity based on a synchronization raster. The PSS may be associated with an OOK bit sequence or a single carrier waveform. The component 198 may be configured to synchronize with the network entity based on the received PSS. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, may include means for receiving a PSS from a network entity based on a synchronization raster. The PSS may be associated with an OOK bit sequence or a single carrier waveform. The apparatus 1104, and in particular the cellular baseband processor 1124 and/or the application processor 1106, may include means for synchronizing with the network entity based on the received PSS.

In one configuration, the synchronization raster may be a multiple of a channel raster. In one configuration, the PSS may include a time domain synchronization signal based on the single carrier waveform. In one configuration, the PSS may be associated with a number of repetitions. In one configuration, the apparatus 1104, and in particular the cellular baseband processor 1124 and/or the application processor 1106, may include means for obtaining a coarse timing estimation based on an auto-correlation operation across a number of repetitions of the PSS. The apparatus 1104, and in particular the cellular baseband processor 1124 and/or the application processor 1106, may include means for obtaining a coarse CFO estimation based on a phase of a peak associated with the PSS. In one configuration, the apparatus 1104, and in particular the cellular baseband processor 1124 and/or the application processor 1106, may include means for obtaining a refined timing estimation or a refined CFO estimation based on a cross-correlation operation between the received PSS and a local PSS copy. In one configuration, the PSS may be based on a ZC sequence or an m-sequence. In one configuration, the PSS may include the OOK bit sequence. The OOK bit sequence may be predefined. In one configuration, the apparatus 1104, and in particular the cellular baseband processor 1124 and/or the application processor 1106, may include means for obtaining a timing estimation based on the PSS. The apparatus 1104, and in particular the cellular baseband processor 1124 and/or the application processor 1106, may include means for refraining from obtaining a CFO estimation. In one configuration, the apparatus 1104, and in particular the cellular baseband processor 1124 and/or the application processor 1106, may include means for transmitting, for the network entity, data based on a free running oscillator. In one configuration, the apparatus 1104, and in particular the cellular baseband processor 1124 and/or the application processor 1106, may include means for receiving data from the network entity without performing down-conversion.

The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to select a PSS. The PSS may be associated with an OOK bit sequence or a single carrier waveform. The component 199 may be configured to transmit, for a UE, the PSS based on a synchronization raster. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for selecting a PSS. The PSS may be associated with an OOK bit sequence or a single carrier waveform. The network entity 1202 may include means for transmitting, for a UE, the PSS based on a synchronization raster.

In one configuration, the synchronization raster may be a multiple of a channel raster. In one configuration, the PSS may include a time domain synchronization signal based on the single carrier waveform. In one configuration, the PSS may be associated with a number of repetitions. In one configuration, the PSS may be based on a ZC sequence or an m-sequence. In one configuration, the PSS may include the OOK bit sequence. The OOK bit sequence may be predefined.

The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

Referring back to FIGS. 4-12, a network entity may select a PSS. The PSS may be associated with an OOK bit sequence or a single carrier waveform. The network entity may transmit, for a UE, the PSS based on a synchronization raster. The UE may synchronize with the network entity based on the received PSS. Accordingly, a suitable PSS may be provided for an ultra-light device/UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving a PSS from a network entity based on a synchronization raster, the PSS being associated with an OOK bit sequence or a single carrier waveform; and synchronizing with the network entity based on the received PSS.

Aspect 2 is the method of aspect 1, where the synchronization raster is a multiple of a channel raster.

Aspect 3 is the method of any of aspects 1 and 2, where the PSS includes a time domain synchronization signal based on the single carrier waveform.

Aspect 4 is the method of aspect 3, where the PSS is associated with a number of repetitions.

Aspect 5 is the method of any of aspects 3 and 4, further including: obtaining a coarse timing estimation based on an auto-correlation operation across a number of repetitions of the PSS; and obtaining a coarse CFO estimation based on a phase of a peak associated with the PSS.

Aspect 6 is the method of aspect 5, further including: obtaining a refined timing estimation or a refined CFO estimation based on a cross-correlation operation between the received PSS and a local PSS copy.

Aspect 7 is the method of any of aspects 3 to 6, where the PSS is based on a ZC sequence or an m-sequence.

Aspect 8 is the method of any of aspects 1 and 2, where the PSS includes the OOK bit sequence, and the OOK bit sequence is predefined.

Aspect 9 is the method of aspect 8, further including: obtaining a timing estimation based on the PSS; and refraining from obtaining a CFO estimation.

Aspect 10 is the method of aspect 9, further including: transmitting, for the network entity, data based on a free running oscillator.

Aspect 11 is the method of any of aspects 9 and 10, further including: receiving data from the network entity without performing down-conversion.

Aspect 12 is a method of wireless communication at a network entity, including selecting a PSS, the PSS being associated with an OOK bit sequence or a single carrier waveform; and transmitting, for a UE, the PSS based on a synchronization raster.

Aspect 13 is the method of aspect 12, where the synchronization raster is a multiple of a channel raster.

Aspect 14 is the method of any of aspects 12 and 13, where the PSS includes a time domain synchronization signal based on the single carrier waveform.

Aspect 15 is the method of aspect 14, where the PSS is associated with a number of repetitions.

Aspect 16 is the method of any of aspects 14 and 15, where the PSS is based on a ZC sequence or an m-sequence.

Aspect 17 is the method of any of aspects 12 and 13, where the PSS includes the OOK bit sequence, and the OOK bit sequence is predefined.

Aspect 18 is an apparatus for wireless communication including at least one processor coupled to a memory and, based at least in part on information stored in the memory, the at least one processor is configured to implement a method as in any of aspects 1 to 17.

Aspect 19 may be combined with aspect 18 and further includes a transceiver coupled to the at least one processor.

Aspect 20 is an apparatus for wireless communication including means for implementing any of aspects 1 to 17.

Aspect 21 is a non-transitory computer-readable storage medium storing computer executable code, where the code when executed by a processor causes the processor to implement any of aspects 1 to 17.

Various aspects have been described herein. These and other aspects are within the scope of the following claims.

1. An apparatus for wireless communication at a user equipment (UE), comprising:
a memory; and
at least one processor coupled to the memory and, based at least in part on information stored in the memory, the at least one processor is configured to:
receive a primary synchronization signal (PSS) from a network entity based on a synchronization raster, the PSS being associated with an on-off keying (OOK) bit sequence or a single carrier waveform; and
synchronize with the network entity based on the received PSS.

2. The apparatus of claim 1, wherein the synchronization raster is a multiple of a channel raster.

3. The apparatus of claim 1, wherein the PSS includes a time domain synchronization signal based on the single carrier waveform.

4. The apparatus of claim 3, wherein the PSS is associated with a number of repetitions.

5. The apparatus of claim 3, the at least one processor being further configured to:
obtain a coarse timing estimation based on an auto-correlation operation across a number of repetitions of the PSS; and
obtain a coarse carrier frequency offset (CFO) estimation based on a phase of a peak associated with the PSS.

6. The apparatus of claim 5, the at least one processor being further configured to:
obtain a refined timing estimation or a refined CFO estimation based on a cross-correlation operation between the received PSS and a local PSS copy.

7. The apparatus of claim 3, wherein the PSS is based on a Zadoff-Chu (ZC) sequence or a maximum length sequence (m-sequence).

8. The apparatus of claim 1, wherein the PSS includes the OOK bit sequence, and the OOK bit sequence is predefined.

9. The apparatus of claim 8, the at least one processor being further configured to:
obtain a timing estimation based on the PSS; and
refrain from obtaining a carrier frequency offset (CFO) estimation.

10. The apparatus of claim 9, the at least one processor being further configured to:
transmit, for the network entity, data based on a free running oscillator.

11. The apparatus of claim 9, the at least one processor being further configured to:
receive data from the network entity without performing down-conversion.

12. The apparatus of claim 1, further comprising a transceiver coupled to the at least one processor, the transceiver being configured to receive the PSS from the network entity.

13. A method of wireless communication at a user equipment (UE), comprising:
receiving a primary synchronization signal (PSS) from a network entity based on a synchronization raster, the PSS being associated with an on-off keying (OOK) bit sequence or a single carrier waveform; and
synchronizing with the network entity based on the received PSS.

14-17. (canceled)

18. An apparatus for wireless communication at a network entity, comprising:
a memory; and
at least one processor coupled to the memory and, based at least in part on information stored in the memory, the at least one processor is configured to:
select a primary synchronization signal (PSS), the PSS being associated with an on-off keying (OOK) bit sequence or a single carrier waveform; and
transmit, for a user equipment (UE), the PSS based on a synchronization raster.

19. The apparatus of claim 18, wherein the synchronization raster is a multiple of a channel raster.

20. The apparatus of claim 18, wherein the PSS includes a time domain synchronization signal based on the single carrier waveform.

21. The apparatus of claim 20, wherein the PSS is associated with a number of repetitions.

22. The apparatus of claim 20, wherein the PSS is based on a Zadoff-Chu (ZC) sequence or a maximum length sequence (m-sequence).

23. The apparatus of claim 18, wherein the PSS includes the OOKbit sequence, and the OOK bit sequence is predefined.

24. The apparatus of claim 18, further comprising a transceiver coupled to the at least one processor, the transceiver being configured to transmit, for the UE, the PSS.

25-30. (canceled)
